(19) United States
(12) Patent Application Publication
(10) Pub. No.: US 2013/0087216 A1
(43) Pub. Date: Apr. 11, 2013

(54) Leaf Blower Apparatus Attachment

(71) Applicant: Adam James Hernandez, Renfrew, PA (US)

(72) Inventor: Adam James Hernandez, Renfrew, PA (US)

(21) Appl. No.: 13/436,960

(22) Filed: Apr. 1, 2012

Related U.S. Application Data
(60) Provisional application No. 61/471,579, filed on Apr. 4, 2011.

(51) Int. Cl. F17D 1/02

(52) U.S. Cl. CPC F17D 1/02
USPC 137/268

(57) ABSTRACT

The Leaf Blower Apparatus Attachment is an attachable apparatus that converts a portable leaf blower machine into a “Dry Materials” distribution unit. The flow of the dry materials is gauged by the open/close slide release handle, which is molded or fitted to the drop box. Gravity is utilized allowing dry materials within the container to be emitted via the hollow tube utilizing the angled drop lip that creates aerodynamic airflow releasing all dry materials via the open end of the hollowed tube for even distribution of said dry materials. When filling the Leaf Blower Apparatus Attachment container it rests steadily on two legs.

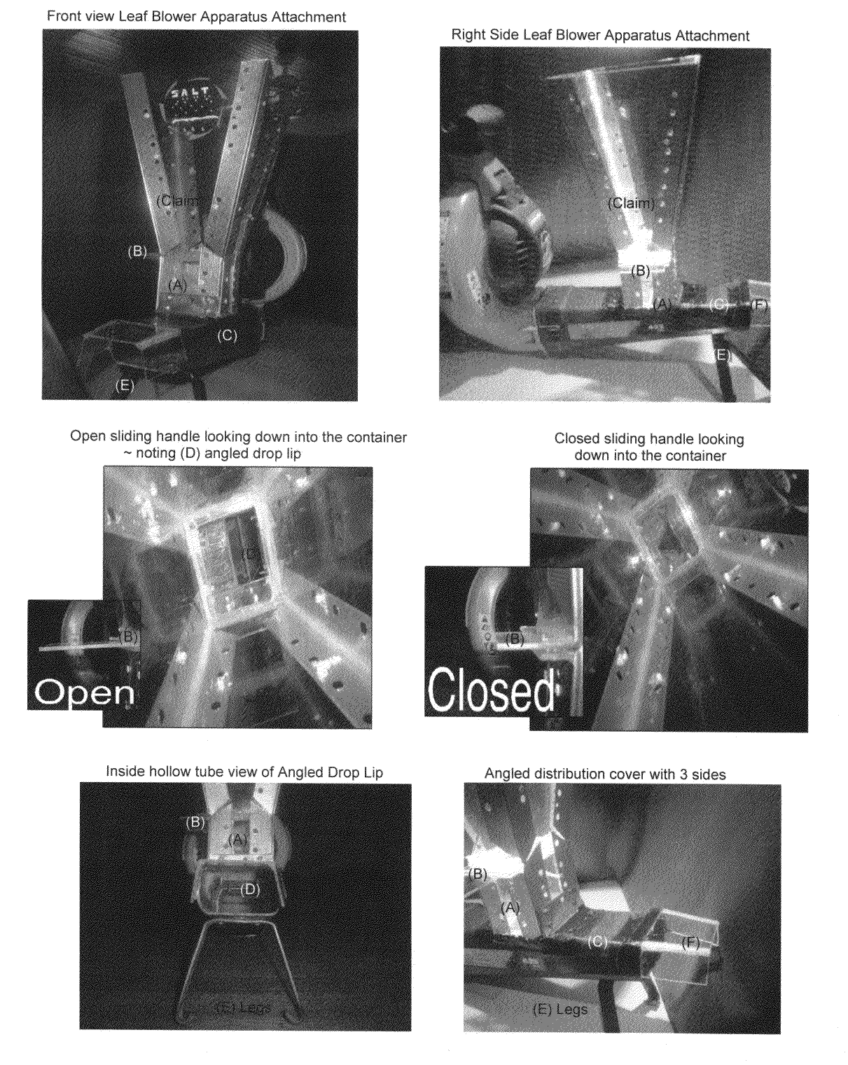

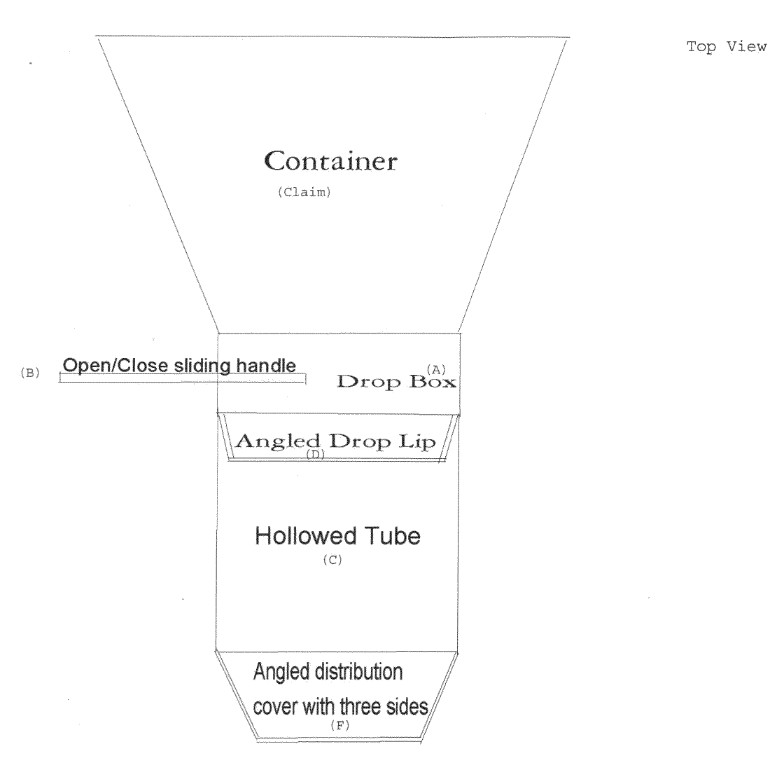

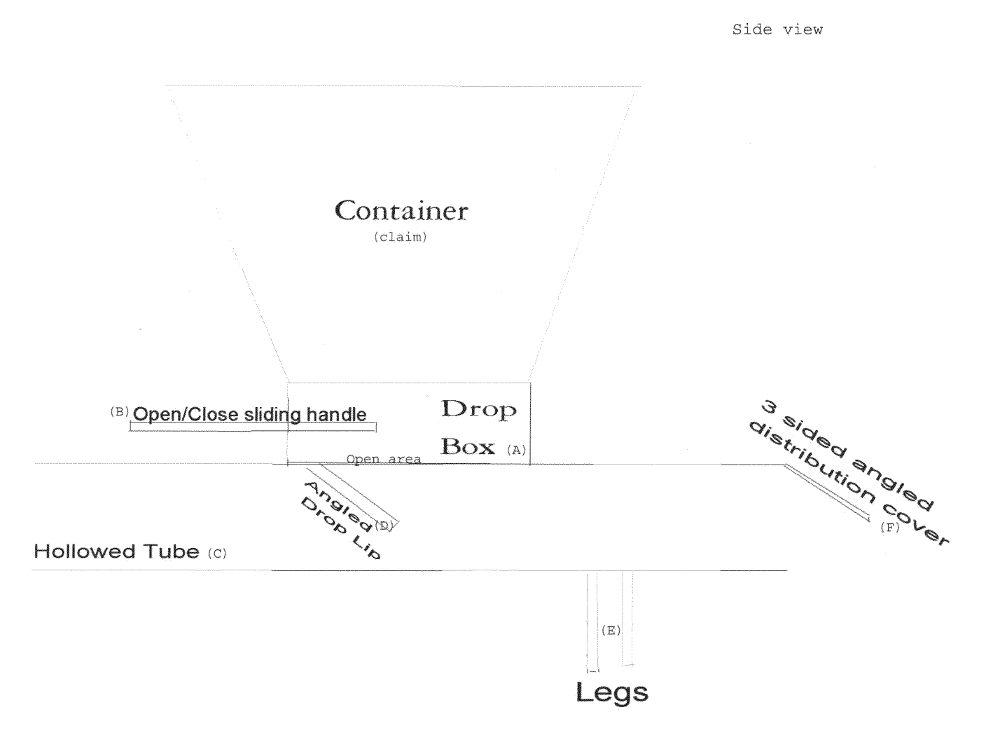

### CROSS-REFERENCE TO RELATED APPLICATIONS

Provisional Application Number 61/471,579

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The Leaf Blower Apparatus Attachment provides a readily portable and attachable apparatus that takes account of a means to convert a portable leaf blower machine into a dry materials distribution unit for quick efficient even distribution amongst the hardest places/areas to reach by human delivery. Utilizing the “Angled Drop Lip” labeled as (A) in Drawings and Photos.

### BACKGROUND ART

Leaf blower dispersing applicator U.S. Pat. No. 7,054,944 granted Jun. 27, 2006 Steele, Timothy Dale (Fulton, MS) Expired Patent Jul. 26, 2010

Broadcast Spreader Attachment For Hand-Held Gas Or Electric Leaf Blowers U.S. Pat. No. 7,086,616 granted Aug. 8, 2006 Murphy, Charles Patrick (Gainesville, Ga.) Patent Expired, Sep. 6, 2010

Portable Particle Spreader/Blower U.S. Pat. No. 7,281,675 granted Oct. 16, 2007 Elrod, Marcos (Brooklyn, N.Y.) Patented Case

Particulate Material Spreader U.S. Pat. No. 7,328,861 granted Feb. 12, 2008 Sagol, Sami (Ramat Hasharon, (Ill.) Expired Patent Mar. 12, 2012

Salt Shooter U.S. Pat. No. 6,840,468 granted Jan. 11, 2005 Barnett, Wade Charles (Penn Valley, Pa.) Patented Case

### REFERENCES TO SPECIFIC PROBLEMS INVOLVED IN THE PRIOR ART

Gravity is utilized allowing the dry materials within the container to be emitted via airflow produced by the leaf blower machine. “Prior Art” does not contain a method for air that is circulated back into the container where “dry materials” are, causing build-up in the container instead of releasing all dry materials.

### BRIEF SUMMARY OF THE INVENTION

The Leaf Blower Apparatus Attachment consists of a container molded or fitted to a drop box that is molded or fitted with an open/close sliding handle, that said drop box is molded or fitted to a hollowed tube that is molded or fitted with an angled drop lip directly under the drop box, that is essential for aero dynamical air flow, and an angled three sided cover at the open end of the tube for even distribution, the apparatus attachment while mounted to the actual leaf blower sits on two legs for support while filling.

Container as Claim dependent upon A-F˜noted in all drawings and photos
(A) Drop box non-specific in size
(B) Open/close sliding release handle
(C) Non-specific size hollowed tube having a hole cut to the specific size as said (A) drop box,
(D) Angled non-specific size drop lip inside the (C) hollow tube
(E) Non-specific size legs
(F) Non-specific size angled three-sided cover

### BRIEF DESCRIPTION OF THE SEVERAL VIEWS OF INVENTION PHOTOS

Blower Machine NOT part of invention merely for aesthetic purposes only

1 separate photo page PDF format
Front view Leaf Blower Apparatus Attachment˜noting (A, B, C, E, F)
Right Side Leaf Blower Apparatus Attachment˜noting (A, B, C, E, F)
Open/Close sliding handle looking down into the container˜noting (B, D)
Inside hollow tube view of Angled Drop Lip & Legs˜noting (A, B, D, E)
Angled distribution cover with three sides˜noting (A, B, C, E, F)

### DETAILED DESCRIPTION OF THE INVENTION

The Leaf Blower Apparatus Attachment consists of a container (Claim) molded together with an (B) open/close sliding handle release (A) drop box mounted to a (C) hollowed tube with a same size cut hole attached to an (D) angled drop lip inside the (C) hollowed tube, that allows aerodynamically flow to continually carry “Dry Materials” quickly and efficiently to any location by utilizing the air from the leaf blower machine. The open end where the “Dry Materials” are emitted has an (F) angled three-sided cover for even square footage distribution of “Dry Materials” which can be done from a standing/sitting position by pivoting the leaf blower machine with the said (Claim) attached. Because gravity is utilized allowing the dry materials within the container to be emitted via hollow tube the angled drop lip creates a method of continual dry material airflow releasing all dry materials. When filling the Leaf Blower Apparatus Attachment container it rests steadily on (E) two legs.

### DRAWINGS

(2 pages, separately attached)

Top view˜noting (A, B, C, D, F)

Side view˜noting (A, B, C, D, E, F)

1. An leaf blower apparatus attachment container of non-specific size molded or fitted together comprising of an (A.) drop box non-specific in size molded or fitted together to said claim having an (B.) open/close sliding release handle molded or fitted together to said (A.) drop box which is molded or fitted together to said claim and molded or fitted together to an (C.) non-specific size hollowed tube having a hole cut to the specific size as said (A.) drop box, (C.) the non-specific size hollowed tube molded or fitted together with an (D.) angled non-specific size drop lip inside the (C.) non-specific size hollowed tube, molded or fitted together with two (E.) non-specific size legs, the (C.) non-specific hollowed tube dispersal end has an (F.) non-specific size angled three-sided cover molded or fitted together with. said (C.) non specific size hollowed tube which is molded or fitted together to said claim for even distribution of any dry material emitted by pivoting said leaf blower apparatus with said claim.
